(19) United States
(12) Patent Application Publication
(10) Pub. No.: US 2025/0054073 A1
(43) Pub. Date: Feb. 13, 2025

(54) METHOD AND APPARATUS FOR SOCIAL NETWORKING SERVICE

(71) Applicant: KAKAO CORP., Jeju-si (KR)

(72) Inventors: Young Jin CHOI, Seongnam-si (KR); Min Jung KIM, Seongnam-si (KR)

(21) Appl. No.: 18/798,660

(22) Filed: Aug. 8, 2024

(30) Foreign Application Priority Data
Aug. 9, 2023 (KR) 10-2023-0104334

(51) Int. Cl. G06Q 50/00

(52) U.S. Cl. CPC G06Q 50/01

(57) ABSTRACT

A method and apparatus for a social networking service are provided. An operating method of a server that provides a social networking service includes determining a layout of a feed page based on following information corresponding to a first user account and subscription information corresponding to the first user account, determining a type of feed content corresponding to the determined layout, based on the following information and the subscription information, and providing, to a terminal of the first user account, the feed page on which the determined feed content is arranged based on the layout.

### CROSS-REFERENCE TO RELATED APPLICATION

This application claims the benefit of Korean Patent Application No. 10-2023-0104334 filed on Aug. 9, 2023, in the Korean Intellectual Property Office, the entire disclosure of which is incorporated herein by reference for all purposes.

### BACKGROUND

### Technical Field

One or more embodiments relate to a method and apparatus for a social networking service (or a social media service).

### Description of the Related Art

Recently, with the development of mobile smart devices, the use of an online platform service to communicate with other users via a network has increased. A representative example of an online platform service for interacting with other users is social networking service (SNS), an online platform that creates and strengthens social relationships through communication between users, information sharing, and expansion of personal networks. As communication through mobile devices increases, various technologies for generating and sharing content are being developed for online platform services.

### BRIEF SUMMARY

Embodiments provide technology for providing a feed page, in which the type of content included and the method of arranging the content are determined according to subscription information and following information of a user.

However, the technical aspects are not limited to the aforementioned aspects, and other technical aspects may be present.

According to an aspect, there is provided an operating method of a server that provides a social networking service including determining a layout of a feed page based on following information corresponding to a first user account and subscription information corresponding to the first user account, determining a type of feed content corresponding to the determined layout, based on the following information and the subscription information, and providing, to a terminal of the first user account, the feed page on which the determined feed content is arranged based on the layout.

The following information may include one of second user account information, which is information related to a second user account for which following is set by the first user account, and information indicating that there is no other user account for which following is set by the first user account.

The subscription information may include one of item group information, which is information related to an item group to which subscription is set by the first user account, and information indicating that there is no item group to which subscription is set by the first user account.

The determining of the layout of the feed page may include at least one of determining the layout of the feed page to include arrangement information of a first type of feed content related to content generated by a second user account, based on second user account information included in the following information or determining the layout of the feed page to include arrangement information of a second type of feed content related to a recommendation corresponding to the second user account information.

The determining of the feed content may include at least one of generating, based on arrangement information of a first type of feed content included in the layout, feed content comprising a post generated by a second user account included in the following information or generating, based on the arrangement information of the first type of feed content included in the layout, feed content related to an item group generated by the second user account.

The determining of the feed content may include generating, based on arrangement information of a second type of feed content included in the layout, feed content that recommends a fourth user account, for which following is set by a second user account included in the following information, as a following target.

The determining of the layout of the feed page may include at least one of determining, based on an item group included in the subscription information, the layout of the feed page to include arrangement information of a third type of feed content related to an update of the item group or determining the layout of the feed page to include arrangement information of a fourth type of feed content related to a recommendation corresponding to the item group.

The determining of the feed content may include at least one of generating feed content notifying that new item information has been added to an item group included in the subscription information, based on arrangement information of a third type of feed content included in the layout or generating feed content notifying that item information has been deleted from the item group included in the subscription information, based on the arrangement information of the third type of feed content included in the layout.

The determining of the feed content may include at least one of generating, based on arrangement information of a fourth type of feed content included in the layout, feed content that recommends a third user account, which has generated an item group included in the subscription information, as a following target or generating, based on the arrangement information of the fourth type of feed content included in the layout, feed content that recommends another item group generated by the third user account as a subscription target.

The determining of the layout of the feed page may include determining the layout of the feed page to include at least one of arrangement information of a fifth type of feed content related to a recommendation of a following target or arrangement information of a sixth type of feed content related to a recommendation of a subscription target.

The determining of the feed content may include extracting at least one user account as a candidate based on at least one of location information of the terminal of the first user account, a number of generated posts, or a generation time of a post and generating feed content that recommends following the extracted candidate.

The determining of the feed content may include extracting at least one user account as a candidate based on at least one of location information of the terminal of the first user account, a number of subscriptions to a generated item group, a number of views of a generated item group, or a generation time of an item group and generating feed content that recommends following the extracted candidate.

The determining of the feed content may include extracting at least one item group as a candidate based on at least one of location information, a number of subscriptions, or a number of views of the terminal of the first user account and generating feed content that recommends a subscription to the extracted candidate.

According to an aspect, there is provided an operating method of a terminal of a user account registered to a social media service including setting at least one of subscription to a generated item group or following of another user account and displaying a feed page generated based on the setting, wherein a layout of the feed page is determined based on a presence of an item group to which subscription is set by the user account and a presence of another user account for which following is set by the user account.

According to an aspect, there is provided a server that provides a social networking service and that includes a processor configured to determine a layout of a feed page based on following information corresponding to a first user account and subscription information corresponding to the first user account, determine a type of feed content corresponding to the determined layout, based on the following information and the subscription information, and provide, to a terminal of the first user account, the feed page on which the determined feed content is arranged based on the layout.

When determining the layout of the feed page, the processor may be configured to perform at least one of determining the layout of the feed page to include arrangement information of a first type of feed content related to content generated by a second user account, based on second user account information included in the following information or determining the layout of the feed page to include arrangement information of a second type of feed content related to a recommendation corresponding to the second user account information.

When determining the layout of the feed page, the processor may be configured to perform at least one of determining, based on an item group included in the subscription information, the layout of the feed page to include arrangement information of a third type of feed content related to an update of the item group or determining the layout of the feed page to include arrangement information of a fourth type of feed content related to a recommendation corresponding to the item group.

When determining the layout of the feed page, the processor may be configured to determine the layout of the feed page to include at least one of arrangement information of a fifth type of feed content related to a recommendation of a following target or arrangement information of a sixth type of feed content related to a recommendation of a subscription target.

According to an aspect, there is provided a terminal of a user account registered to a social media service including a processor configured to set at least one of a subscription to a generated item group or following for another user account and display a feed page generated based on the setting, wherein a layout of the feed page is determined based on a presence of an item group to which subscription is set by the user account and a presence of another user account for which following is set by the user account.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a flowchart illustrating an operation of a server that provides a social networking service, according to an embodiment;

FIG. 2 is a diagram for illustrating a following setting and a subscription setting according to an embodiment;

FIG. 3 is a diagram for illustrating recommended information based on a following target, according to an embodiment;

FIG. 4 is a diagram for illustrating recommended information based on a subscription target, according to an embodiment;

FIGS. 5A to 5D are diagrams illustrating a layout of a feed page according to an embodiment;

FIGS. 6A to 6D are diagrams illustrating an interface screen for providing a feed page through a map application, according to an embodiment;

FIGS. 7A and 7B are diagrams illustrating a first type of feed content related to a place, according to an embodiment;

FIG. 8 is a diagram illustrating a second type of feed content related to a place, according to an embodiment;

FIG. 9 is a diagram illustrating a third type of feed content related to a place, according to an embodiment;

FIGS. 10A and 10B are diagrams illustrating a fourth type of feed content related to a place; according to an embodiment;

FIGS. 11A and 11B are diagrams illustrating a fifth type of feed content related to a place, according to an embodiment;

FIG. 12 is a diagram illustrating a sixth type of feed content related to a place, according to an embodiment;

FIG. 13 is a diagram illustrating a seventh type of feed content related to a place, according to an embodiment; and

FIG. 14 is a diagram illustrating an example of a hardware configuration of a system for a social networking service, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The text “at least one of A or B” as used herein should be understood to mean “only A, only B, or both A and B.”

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

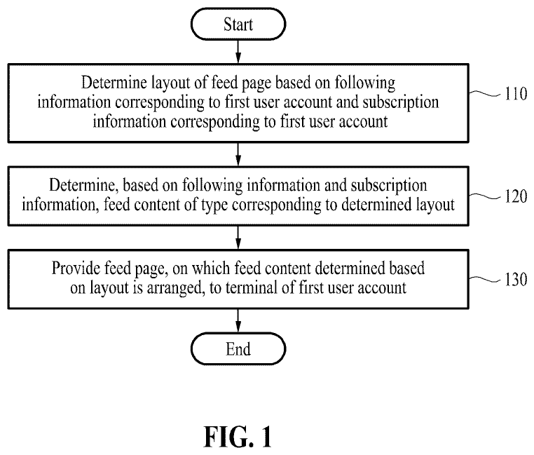

FIG. 1 is a flowchart illustrating an operation of a server that provides a social networking service, according to an embodiment.

A social networking service, or a social media service, is a service for generating and sharing content through a network and may include, for example, a blog service and an instant messaging service. The server that provides a social networking service may interoperate with an application (hereinafter, an app) or Web related to a social networking service that runs on a terminal, supporting a user interface (UI), a function, an operation, a service, or the like. Hereinafter, an app related to a social networking service or Web related to a social networking service may be briefly referred to as an app or Web.

The terminal may receive a service and/or content from a server through the app or the Web. The terminal may refer to one of electronic devices, such as a computer, a portable computer, a wireless phone, a mobile phone, a smartphone, a personalized digital assistant (PDA), a Web tablet, a wearable device, and any other device that may install and execute the app or run the Web. For example, under the control by the app or the Web, the terminal may perform overall service operations, such as service screen setting, data input, data transmission and reception, and data storage. For example, the terminal may process a UI or user interaction through a processor and may output or transmit a processing result through an output device of the terminal.

A user may use a social networking service provided by a server by running the app or the Web on the terminal. A user may create a user account by signing up for the social networking service through the app or the Web. A user may use the social networking service through a terminal logged in with an account (or the user account) registered with the social networking service. A terminal of the user account may refer to a terminal logged in with the user account registered with the social networking service. Hereinafter, when the user account is described as a subject of an action or behavior, the user account may be interpreted as the terminal of the user account or a person (or a user) that uses the terminal of the user account.

A social networking service may include a feed page provision function. The feed page may be a page on which a stream of content is displayed and may include, for example, a page listing blocks including content of a predetermined standard. The feed page may be a page that includes feed content related to following information and/or subscription information of the user account and may be generated in response to the user account.

Referring to FIG. 1, an operating method of a server may include operation 110 of determining a layout of a feed page based on following information corresponding to a first user account and subscription information corresponding to the first user account. The first user account may indicate a user account of the terminal on which the feed page is displayed.

The following information corresponding to the first user account may include following target information, which is information related to a following target set by the first user account. The following target may include at least one other user account.

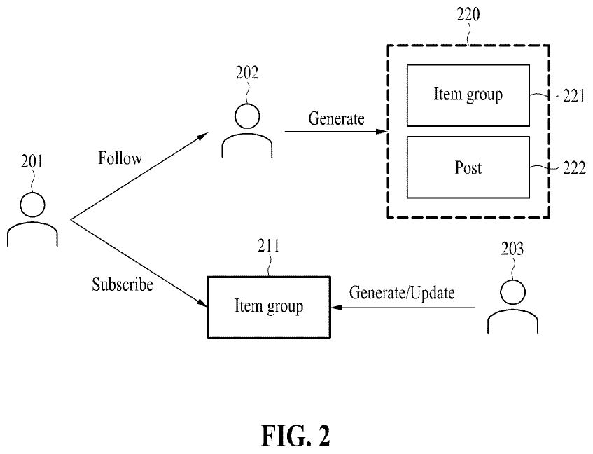

For example, referring to FIG. 2, a first user account 201 or a terminal of the first user account 201 may set following for at least one other user account (e.g., a second user account 202). The at least one other user account for which following is set by the first user account 201 may be referred to as a second user account 202. The second user account 202 may be plural in number. The second user account 202 may be referred to as the following target of the first user account 201, and the first user account 201 may be referred to as a follower of the second user account 202.

The following information may include one of second user account information, which is information related to the second user account for which following is set by the first user account, and information indicating that there is no user account for which following is set by the first user account. For example, when the first user account sets the second user account as the following target, the following information corresponding to the first user account may include the second user account information. For example, the first user account may not set a following target, in which case the following information corresponding to the first user account may include information indicating that there is no user account for which following is set by the first user account.

The subscription information corresponding to the first user account may include subscription target information, which is information related to a subscription target set by the first user account. The subscription target may include at least one item group.

The item group may be a set of at least one object that may be classified into at least one category by certain criteria, for example, a set of place objects registered in a map app, a set of place objects classified into a specific category (e.g., a restaurant, a cafe, and a tourist attraction), a set of place objects classified into a specific category and a similar category, and a set of shopping product objects registered on an e-commerce platform. The item group may be generated by the user account. The user account may generate or register at least one item (e.g., a place object and a shopping product object) that is registered on the server or on a platform interoperating with the server as an item group.

For example, referring to FIG. 2, the first user account 201 or the terminal of the first user account 201 may set a subscription to at least one item group 211. The item group 211 may be an item group generated by another user account. The another user account that generated the item group to which subscription is set by the first user account 201 may be referred to as a third user account 203.

The subscription information may include one of item group information, which is information related to the item group to which subscription is set by the first user account, and information indicating that there is no item group to which subscription is set by the first user account. For example, when the first user account sets an item group as the subscription target, the subscription information corresponding to the first user account may include the item group set as the subscription target. For example, the first user account may not set a subscription target, in which case the subscription information corresponding to the first user account may include information indicating that there is no item group to which subscription is set by the first user account.

The layout of the feed page may include arrangement information of feed content by type. The feed content may be a unit of content displayed on the feed page. The feed content may be classified into a plurality of types, and the types of feed content are described in detail below. The arrangement information of a specific type of feed content may include at least one of information indicating a position, within the feed page, on which feed content of the corresponding type is displayed, information indicating a size at which the feed content of the corresponding type is displayed within the feed page, or information indicating a number of pieces of feed content of the corresponding type arranged within the feed page.

The layout of the feed page may be determined based on an existence of the second user account for which following is set by the first user account and/or an existence of an item group to which subscription is set by the first user account. Based on the existence of the second user account for which following is set by the first user account and/or the existence of an item group to which subscription is set by the first user account, a type of feed content, of which the arrangement information is to be included in the layout, may be determined.

Operation 110 of determining a layout of a feed page may include determining, based on second user account information included in the following information, a layout of a feed page to include arrangement information of a first type of feed content related to content generated by the second user account. In other words, when there is the second user account for which following is set by the first user account, the determined layout may include the arrangement information of the first type of feed content. For example, when the following information includes information indicating that there is no user account for which following is set by the first user account, the determined layout may not include the arrangement information of the first type of feed content. The first type of feed content is described in detail below.

When arrangement information of a specific type of feed content is included in the layout, feed content of the corresponding type may be arranged on the feed page. On the contrary, when arrangement information of a specific type of feed content is not included in the layout, feed content of the corresponding type may not be arranged on the feed page.

Operation 110 of determining a layout of a feed page may include determining a layout of a feed page to include arrangement information of a second type of feed content related to a recommendation corresponding to the second user account information. In other words, when there is the second user account for which following is set by the first user account, the determined layout may include arrangement information of the second type of feed content. For example, when the following information includes information indicating that there is no user account for which following is set by the first user account, the determined layout may not include the arrangement information of the second type of feed content. The second type of feed content is described in detail below.

Operation 110 of determining a layout of a feed page may include determining, based on an item group included in the subscription information, a layout of a feed page to include arrangement information of a third type of feed content related to an update of the item group. In other words, when there is an item group to which subscription is set by the first user account, the determined layout may include arrangement information of the third type of feed content. For example, when the subscription information includes the information indicating that there is no item group to which subscription is set by the first user account, the determined layout may not include the arrangement information of the third type of feed content. The third type of feed content is described in detail below.

Operation 110 of determining a layout of a feed page may include determining a layout of a feed page to include arrangement information of a fourth type of feed content related to a recommendation corresponding to the item group. In other words, when there is an item group to which subscription is set by the first user account, the determined layout may include the arrangement information of the fourth type of feed content. For example, when the subscription information includes the information indicating that there is no item group to which subscription is set by the first user account, the determined layout may not include the arrangement information of the fourth type of feed content. The fourth type of feed content is described in detail below.

The layout may be determined to include arrangement information of a specific type of feed content regardless of the existence of the second user account for which following is set by the first user account and/or the existence of an item group to which subscription is set by the first user account.

For example, operation 110 of determining a layout of a feed page may include determining a layout of a feed page to include at least one of arrangement information of a fifth type of feed content related to a recommendation of a following target or arrangement information of a sixth type of feed content related to a recommendation of a subscription target. The fifth type of feed content and/or the sixth type of feed content may be included in the feed page regardless of the existence of the second user account for which following is set by the first user account and/or the existence of an item group to which subscription is set by the first user account.

An operating method of a server may include operation 120 of determining, based on following information and subscription information, feed content of a type corresponding to the determined layout. When the determined layout includes arrangement information of a specific type of feed content, the feed content of the corresponding type to be arranged on the feed page may be extracted or generated.

Operation 120 of determining feed content may include at least one of generating feed content including a post generated by the second user account included in the following information, based on the arrangement information of the first type of feed content included in the layout, or generating feed content related to an item group generated by the second user account, based on the arrangement information of the first type of feed content included in the layout. For example, when a new item group is generated by the second user account, the feed content related to the item group may include information notifying the newly generated item group. For example, when the item group generated by the second user account is updated, the feed content related to the item group may include information notifying the update of the item group.

The first type of feed content may include content generated by the second user account. For example, referring to FIG. 2, content 220 generated by the second user account 202 may include at least one item group 221. The content 220 generated by the second user account 202 may include at least one post 222. A post may be data registered in a posting space within a social networking service and may include, for example, multimedia content including at least one of text, image, video, or file. The first type of feed content may include a post 222 and/or information on the item group 221 generated by the second user account 202.

A portion of the content generated by the second user account may be selected and generated as feed content to be arranged on the feed page. When the arrangement information of the first type of feed content included in the layout includes information indicating a number of pieces of the first type of feed content arranged in the feed page, the corresponding number of pieces of first type of feed content may be determined. Among content including information on the post and the item group generated by the second user account, the number of pieces of content determined by the layout may be selected to be generated as feed content. For example, a portion of the content generated by the second user account may be selected in a reverse order of generation time, or content generated by the second user account with high importance set by the first user account may be preferentially selected.

Operation 120 of determining feed content may include generating, based on arrangement information of a second type of feed content included in the layout, feed content that recommends a fourth user account 304, for which following is set by the second user account included in the following information, as a following target.

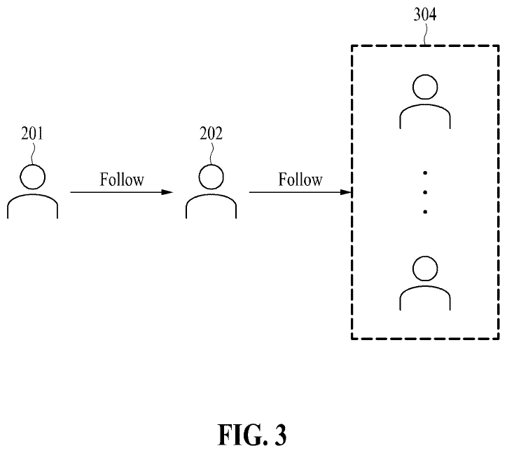

The second type of feed content may include information that recommends the fourth user account 304, for which following is set by the second user account, as a following target. For example, referring to FIG. 3, the second user account 202 for which following is set by the first user account 201 may follow at least one other user account. The at least one other user account for which following is set by the second user account 202 may be referred to as the fourth user account 304. The second type of feed content may include information that recommends following at least one of the fourth user account 304.

A portion of the fourth user account may be selected and the second type of feed content recommending the selected fourth user account as a following target may be generated. For example, a portion of the fourth user account may be selected in an order of the most content generated, or a portion of the fourth user account may be selected in an order of the most recently generated content. For example, a portion of the fourth user account may be selected in an order of a number of followers, or a portion of the fourth user account may be selected in an order of a number of second user accounts included in a follower.

Operation 120 of determining feed content may include at least one of generating feed content notifying that new item information has been added to the item group included in the subscription information, based on the arrangement information of a third type of feed content included in the layout, and generating feed content notifying that item information has been deleted from the item group included in the subscription information, based on the arrangement information of the third type of feed content included in the layout.

The third type of feed content may include update information of the item group to which subscription is set by the first user account. The update information of the item group may include change information related to addition or deletion of an item included in the item group.

A portion of the update information of the item group to which subscription is set may be selected and generated as feed content to be arranged on the feed page. When the arrangement information of the third type of feed content included in the layout includes information indicating a number of pieces of the third type of feed content arranged in the feed page, the corresponding number of pieces of the third type of feed content may be determined. Among update information of the item group to which subscription is set, update information of the number of item groups determined by the layout may be selected to be generated as feed content. For example, a portion of the update information of subscription item groups may be selected in an order of late update time, or update information of an item group having high importance set by the first user account may be preferentially selected.

Operation 120 of determining feed content may include at least one of generating feed content recommending the third user account that has generated an item group included in the subscription information as a following target, based on the arrangement information of the fourth type of feed content included in the layout, and generating feed content recommending another item group generated by the third user account as a subscription target, based on the arrangement information of the fourth type of feed content included in the layout.

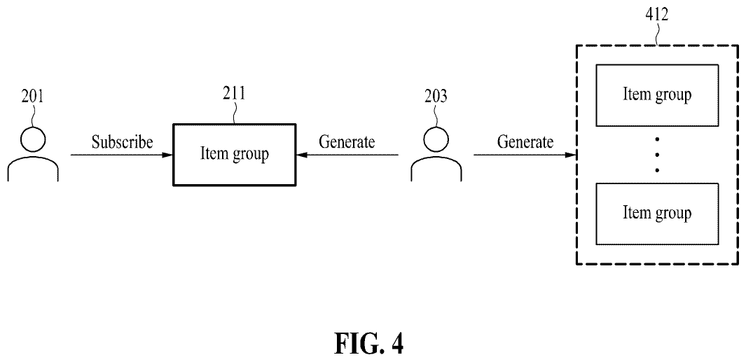

The fourth type of feed content may include information recommending the third user account that has generated the item group included in the subscription information as a following target. The fourth type of feed content may include information recommending another item group generated by the third user account as a subscription target. For example, referring to FIG. 4, the item group 211 to which subscription is set by the first user account 201 may correspond to content generated by the third user account 203. The fourth type of feed content may include information that recommends following the third user account 203. The content generated by the third user account 203 may include at least one other item group 412 in addition to the item group 211. The fourth type of feed content may include information that recommends subscribing to the at least one other item group 412 generated by the third user account 203.

A portion of the third user account may be selected and the fourth type of feed content recommending the selected third user account as a following target may be generated. For example, a portion of the third user account may be selected in an order of the most content generated, or a portion of the third user account may be selected in an order of the most recently generated content. For example, a portion of the third user account may be selected in an order of the number of followers, or a portion of the third user account may be selected in an order of a number of subscriptions to and/or views of the item group generated by the third user account.

A portion of other item groups generated by the third user account may be selected and the fourth type of feed content recommending the selected item groups as a subscription target may be generated. For example, a portion of the other item groups generated by the third user account may be selected in an order of a number of subscriptions and/or views. For example, a portion of the other item groups generated by the third user account may be selected in an order of a number of included items. For example, a portion of the other item groups generated by the third user account may be selected based on location information of the first user account. More specifically, in the case of an item group including a place object, an item group including a place object located close to a location of a terminal of the first user account (e.g., a place object located within a threshold distance and/or a place object located in a same administrative district as the location of the terminal of the first user account) may be selected.

Operation 120 of determining feed content may include extracting at least one user account as a candidate based on at least one of a number of generated posts or a generation time of a post and generating feed content that recommends following the extracted candidate. Among all user accounts subscribed to a service, a portion of user accounts may be extracted as a candidate based on criteria regarding a post. For example, a portion of user accounts may be extracted as a candidate in an order of the most number of posts generated by the user account. For example, a portion of user accounts may be extracted as a candidate in an order of the most recently generated post.

Operation 120 of determining feed content may include extracting at least one user account as a candidate based on location information of the terminal of the first user account and generating feed content that recommends following the extracted candidate. For example, based on a degree of relevance between location information included in a post and the location information of the terminal of the first user account, a user account that generated the corresponding post may be extracted as a candidate. For example, the location information included in the post may include at least one of information indicating the location in which the post was generated, tag information on the location included in the post, or information on a place object included in the post. A portion of user accounts may be extracted as a candidate in an order of proximity of the location information included in the generated post to the location information of the terminal of the first user account.

Operation 120 of determining feed content may include extracting at least one user account as a candidate based on at least one of the number of subscriptions to the generated item group, the number of views of the generated item group, or a generation time of the item group and generating feed content that recommends following the extracted candidate. Among all the user accounts subscribed to the service, a portion of user accounts may be extracted as a candidate based on criteria regarding an item group. For example, a portion of user accounts may be extracted as a candidate in an order of a number of subscriptions to item groups generated by the user account. For example, a portion of user accounts may be extracted as a candidate in an order of a number of views of an item group generated by the user account. For example, a portion of user accounts may be extracted as a candidate in an order of the most recently generated item group.

Operation 120 of determining feed content may include extracting at least one user account as a candidate based on location information of the terminal of the first user account and generating feed content that recommends following the extracted candidate. Based on a degree of relevance between location information included in the item group and the location information of the terminal of the first user account, a user account that generated the corresponding item group may be extracted as a candidate. For example, the location information included in the item group may include information indicating a location of a place object included in the item group. A portion of user accounts may be extracted as a candidate in an order of proximity of the location information included in the generated item group to the location information of the terminal of the first user account.

Feed content that recommends following the user account extracted as a candidate may correspond to the fifth type of feed content. When the layout includes arrangement information of the fifth type of feed content, the fifth type of feed content to be arranged on the feed page may be generated. For example, the fifth type of feed content may be included in the feed page regardless of the existence of the second user account for which following is set by the first user account and/or the existence of an item group to which subscription is set by the first user account.

Operation 120 of determining feed content may include extracting at least one item group as a candidate based on at least one of the number of subscriptions or a number of views and generating feed content that recommends a subscription to the extracted candidate. For example, a portion of all generated item groups may be extracted as a candidate in an order of the number of subscriptions. For example, a portion of all the generated item groups may be extracted as a candidate in an order of the number of views.

Operation 120 of determining feed content may include extracting at least one item group as a candidate based on the location information of the terminal of the first user account and generating feed content that recommends a subscription to the extracted candidate. For example, in the case of an item group including a place object, an item group, among all generated item groups, which includes a place object located close to the location of the terminal of the first user account (e.g., a place object located within the threshold distance and/or a place object located in the same administrative district as the location of the terminal of the first user account) may be extracted as a candidate.

Feed content that recommends a subscription to the item group extracted as a candidate may correspond to the sixth type of feed content. When the layout includes arrangement information for the sixth type of feed content, the sixth type of feed content to be arranged on the feed page may be generated. For example, the sixth type of feed content may be included in the feed page regardless of the existence of the second user account for which following is set by the first user account and/or the existence of an item group to which subscription is set by the first user account.

An operating method of a server may include operation 130 of providing a feed page, on which feed content determined based on the layout is arranged, to the terminal of the first user account. Based on the arrangement information of a specific type of feed content included in the layout, feed content of the corresponding type may be arranged on the feed page. For example, the feed content may be arranged in a location within the feed page indicated by the arrangement information and in a size indicated by the arrangement information. For example, a number of feed contents indicated by the arrangement information may be arranged in the location within the feed page indicated by the arrangement information and in the size indicated by the arrangement information.

When a plurality of feed contents of a same type is arranged, the plurality of feed contents may be sorted according to predetermined criteria. For example, in the case of the first type of feed content, a plurality of first type of feed contents may be sorted based on a generation time of a post or an item group. More specifically, a plurality of first type of feed contents may be sorted within the feed page, for example, in an order of a recently generated post or item group included. A first type of feed content including the most recently generated post or item group may be located at the top of the feed page among the plurality of first type of feed contents.

The server may provide a feed page on which feed content is arranged based on the layout to the terminal of the first user account. The terminal of the first user account may display the feed page.

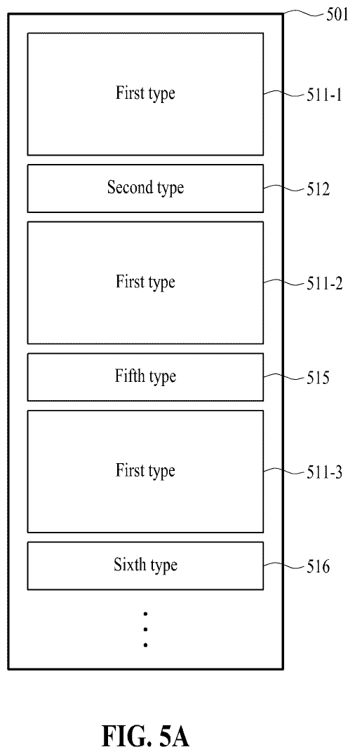

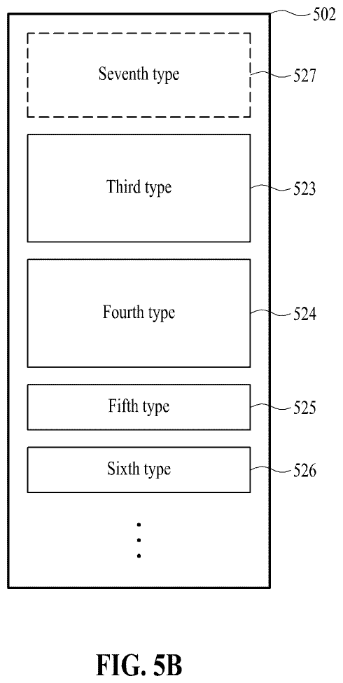

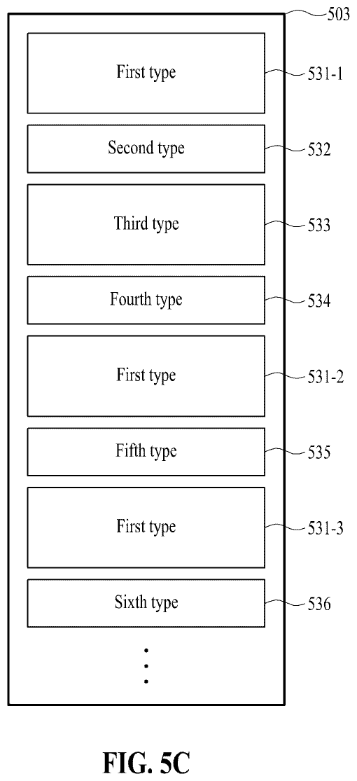

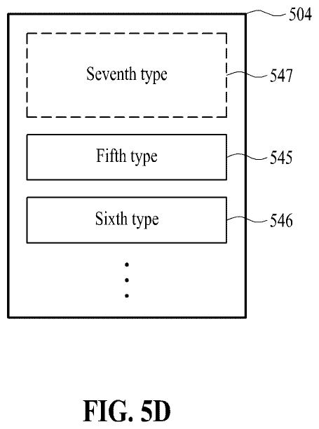

FIGS. 5A to 5D are diagrams illustrating a layout of a feed page according to an embodiment.

For example, a layout 501 of FIG. 5A may be a layout corresponding to a case in which a following target of a first user account exists and an item group to which the first user account subscribes does not exist. Referring to FIG. 5A, the layout 501 may include arrangement information 511-1, 511-2, and 511-3 of a first type of feed content and arrangement information 512 of a second type of feed content. The arrangement information 511-1, 511-2, and 511-3 of the first type of feed content and the arrangement information 512 of the second type of feed content may be included in a layout corresponding to the case in which a following target of the first user account exists.

For example, the layout 501 may include arrangement information 515 of a fifth type of feed content and arrangement information 516 of a sixth type of feed content that may be included in the feed page regardless of the existence of the following target and the existence of the item group that is subscribed to.

The arrangement information 511-1, 511-2, and 511-3 of the first type of feed content may indicate an area in the feed page in which the first type of feed content is displayed. Similarly, the arrangement information 512 of the second type of feed content may indicate an area in the feed page in which the second type of feed content is displayed. For example, as indicated by the arrangement information 511-1, 511-2, and 511-3 of the first type of feed content, the first type of feed content may be displayed in a plurality of areas within the feed page.

For example, the arrangement information 511-1, 511-2, and 511-3 of the first type of feed content may include information indicating a number of pieces of feed content included in the indicated area. For example, four pieces of feed contents may be determined to be arranged in the area indicated by the arrangement information 511-1, 511-2, and 511-3 of the first type of feed content. As described above, when a plurality of feed contents of the same type is to be arranged, the plurality of feed contents may be sorted according to predetermined criteria.

For example, a layout 502 of FIG. 5B may be a layout corresponding to a case in which a following target of the first user account does not exist and an item group to which the first user account subscribes exists. Referring to FIG. 5B, the layout 502 may include arrangement information 523 of a third type feed content and arrangement information 524 of a fourth type feed content. The arrangement information 523 of the third type of feed content and the arrangement information 524 of the fourth type of feed content may be included in the layout corresponding to the case in which an item group to which the first user account subscribes exists.

For example, the layout 502 may include arrangement information 525 of the fifth type of feed content and arrangement information 526 of the sixth type of feed content that may be included in the feed page regardless of the existence of the following target and the existence of the item group that is subscribed to.

For example, the layout 502 may include arrangement information 527 of a seventh type of feed content related to inducing a following setting. The arrangement information 527 of the seventh type of feed content may be included in the layout corresponding to the case in which a following target of the first user account does not exist.

For example, a layout 503 of FIG. 5C may be a layout corresponding to a case in which both a following target of the first user account and an item group to which the first user account subscribes exist. Referring to FIG. 5C, the layout 503 may include arrangement information 531-1, 531-2, and 531-3 of the first type of feed content, arrangement information 532 of the second type of feed content, arrangement information 533 of the third type of feed content, and arrangement information 534 of the fourth type of feed content.

For example, the layout 503 may include arrangement information 535 of the fifth type of feed content and arrangement information 536 of the sixth type of feed content that may be included in the feed page regardless of the existence of the following target and the existence of the item group that is subscribed to.

For example, a layout 504 of FIG. 5D may be a layout corresponding to a case in which neither a following target of the first user account nor an item group to which the first user account subscribes exists. Referring to FIG. 5D, the layout 504 may include arrangement information 545 of the fifth type of feed content and arrangement information 546 of the sixth type of feed content that may be included in the feed page regardless of the existence of the following target and the existence of the item group that is subscribed to.

For example, the layout 504 may include arrangement information 547 of the seventh type of feed content related to inducing a following setting.

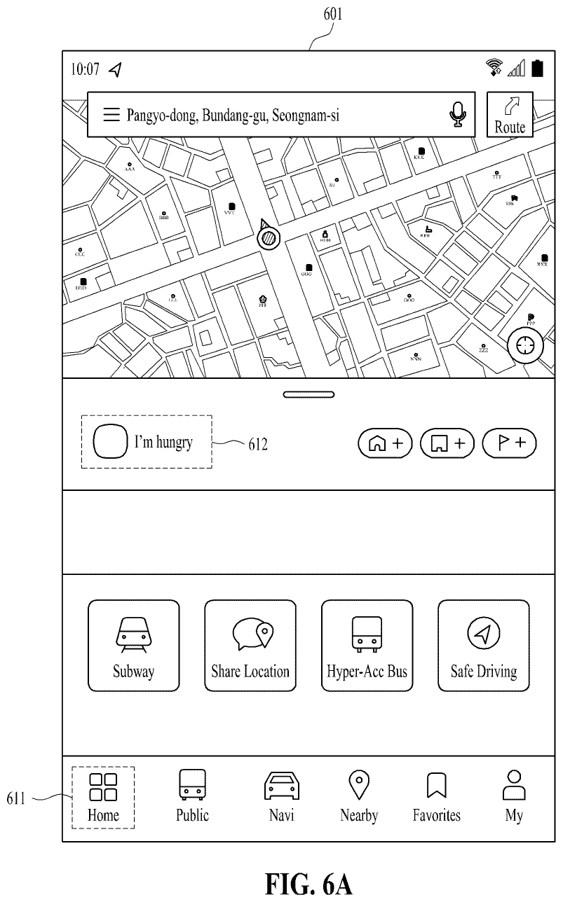

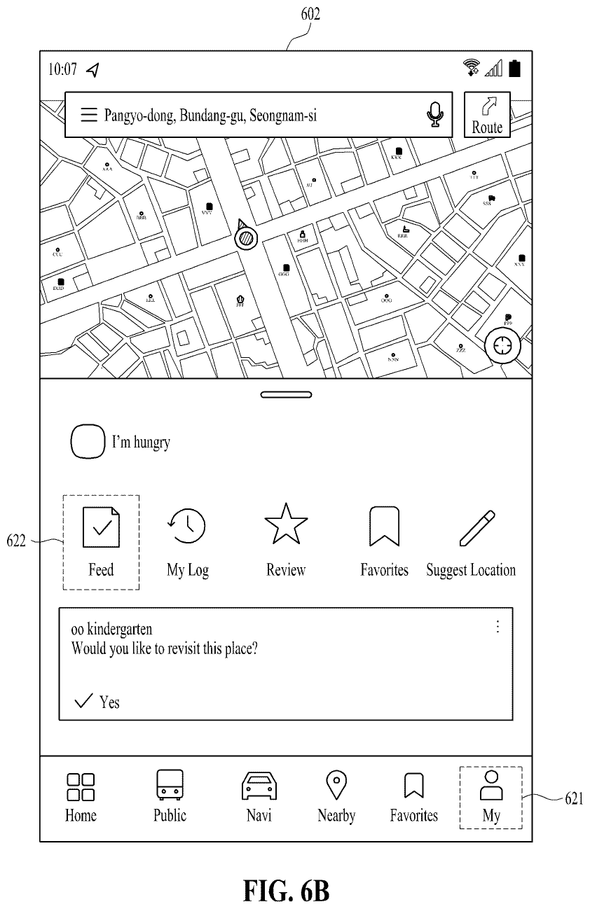

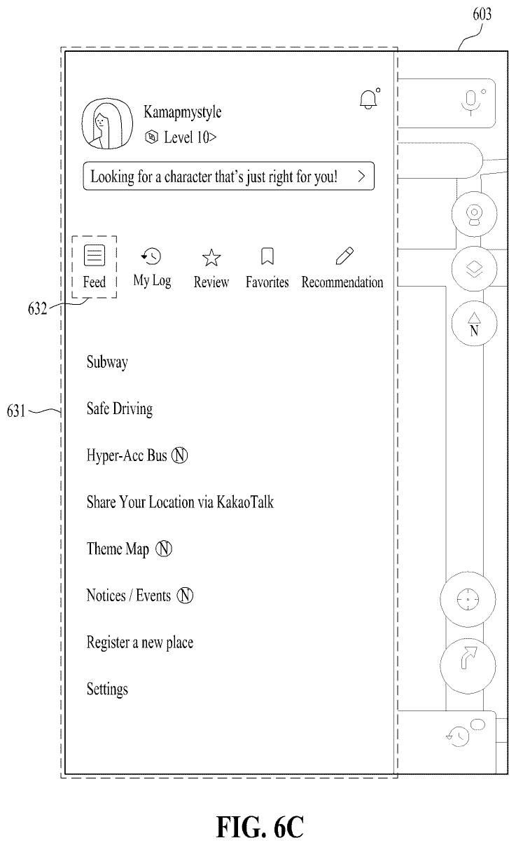

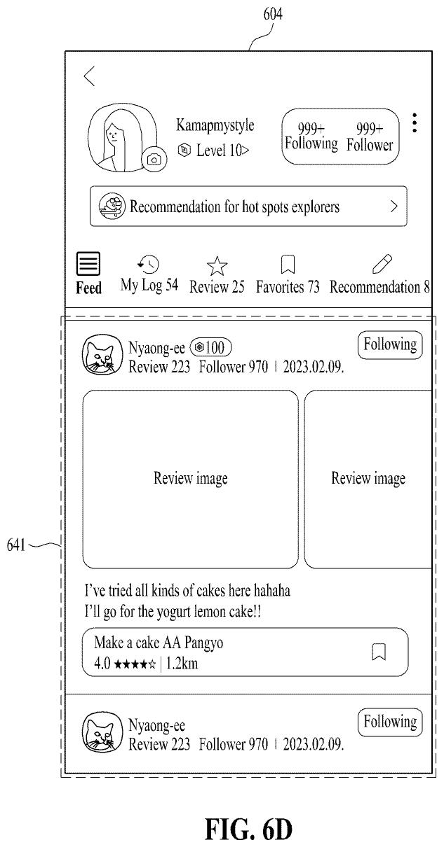

FIGS. 6A and 6B are diagrams illustrating an interface screen for providing a feed page through a map app, according to an embodiment.

A social networking service may interoperate with another service or an app related to another service. For example, a social networking service may interoperate with a map app (or map Web). For example, a map app or map Web may include at least one of a navigation function (e.g., driving directions, public transportation directions, walking directions, and shared transportation directions), a place search function, a place information provision function, a place review writing function, a road view provision function, a location group provision function, or a location recommendation function. For example, a social networking service for generating and sharing content on a place may be provided through a map app. In this case, the app or Web related to the social networking service may include a map app or a map Web.

A feed page corresponding to a user account logged into a terminal may be provided through the map app. For example, screens (e.g., a screen 601, a screen 602, a screen 603, and a screen 604) shown in FIGS. 6A to 6D may be examples of screens displayed on a terminal of a first user account. Hereinafter, the terminal may refer to the terminal of the first user account.

For example, the screen 601 of FIG. 6A may be a home screen displayed by default when running the map app or a home screen displayed by an input selecting a home button 611 of the map app. By an input selecting a profile area 612 displayed on the home screen, the screen 601 may be switched to the screen 604 of FIG. 6D for providing a feed page.

For example, the screen 602 of FIG. 6B may be a My Page screen displayed by an input selecting a My Page button 621 of the map app. A button 622 that navigates to the feed page may be provided through a menu in the My Page screen. By an input selecting the button 622, the screen 602 may be switched to the screen 604 of FIG. 6D for providing a feed page.

For example, referring to the screen 603 of FIG. 6C, a button 632 that navigates to a feed page may be provided through a side menu 631 of the map app. By an input selecting the button 632, the screen 603 displaying the side menu 631 may be switched to the screen 604 of FIG. 6D for providing a feed page.

Referring to the screen 604 of FIG. 6D, a feed page 641 including feed content related to a place may be displayed. As described above, the feed page 641 may include feed content of a type determined based on following information corresponding to the first user account and subscription information corresponding to the first user account.

For example, the feed page 641 may include a first type of feed content related to content generated by a second user account. The first type of feed content may include a post related to a place, such as a review of the place. The first type of feed content may include an item group related to the place. The item group related to the place may include a place group, which is a set of place object(s). The place group may include a set of place objects corresponding to a specific topic or category. The place object may be a data unit for identifying a place registered in the map app and may include, for example, at least one of a category (e.g., a restaurant, a cafe, a beauty salon, and a park), a business name, an address, a phone number, or introduction information of the place.

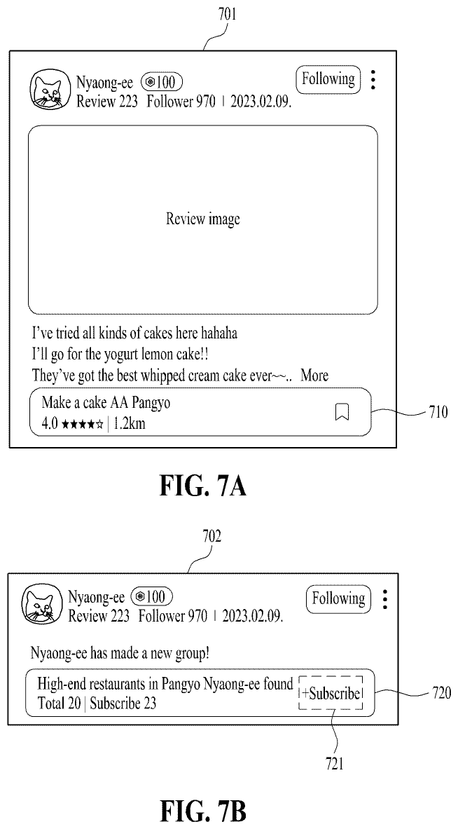

For example, referring to FIG. 7A, a first type of feed content 701 may correspond to feed content including a post about the place generated by the second user account. The feed content 701 may include review information on a specific place generated by the second user account. For example, the review information may include at least one of image-type content or text-type content on the place. For example, the review information may include various types of content (e.g., a video and a file) in addition to image-type and text-type contents.

The feed content 701 may include an interfacing object 710 for providing information on a place that is a subject of the review. The interfacing object 710 may include identification information of the place (e.g., a name and a category of the place). The interfacing object 710 may further include detailed information on the place that includes at least one of evaluation information on the place and distance information from the location of the terminal of the first user account. For example, a screen may be switched to a screen providing the detailed information on the place by an input selecting the interfacing object 710. The screen providing the detailed information on the place may display a detail page regarding the place provided by the map app. The detail page regarding the place may include at least one of a map location, a category (e.g., a restaurant, a cafe, a beauty salon, and a park), a business name, an address, a phone number, or introduction information of the place.

The feed content 701 may include information on the second user account that generated the review information. For example, the feed content 701 may include identification information (e.g., an ID, a nickname, and a name) of the second user account, information on a number of reviews generated by the second user account and a number of followers of the second user account, and the like.

For example, referring to FIG. 7B, a first type of feed content 702 may correspond to feed content that includes a place group generated by the second user account. For example, when a new place group is generated by the second user account, which is a following target, the feed content 702 including the newly generated place group may be generated. The feed content 702 may include an interfacing object 720 related to the place group generated by the second user account. The interfacing object 720 related to the place group may include information on the place group, such as a name of the place group, a number of place objects included in the place group, and a number of subscriptions to the place group. By an input selecting the interfacing object 720, a screen for viewing the place object(s) included in the place group may be provided. The interfacing object 720 may include an interfacing object 721 for setting a subscription to a place group. A place group may be set as a subscription target by an input for selecting the interfacing object 721.

The feed content 702 may include a message notifying that a new place group has been generated by the second user account.

The feed content 702 may include information on the second user account that generated the place group. For example, the feed content 702 may include the identification information (e.g., an ID, a nickname, and a name) of the second user account, the information on the number of reviews generated by the second user account and the number of followers of the second user account, and the like.

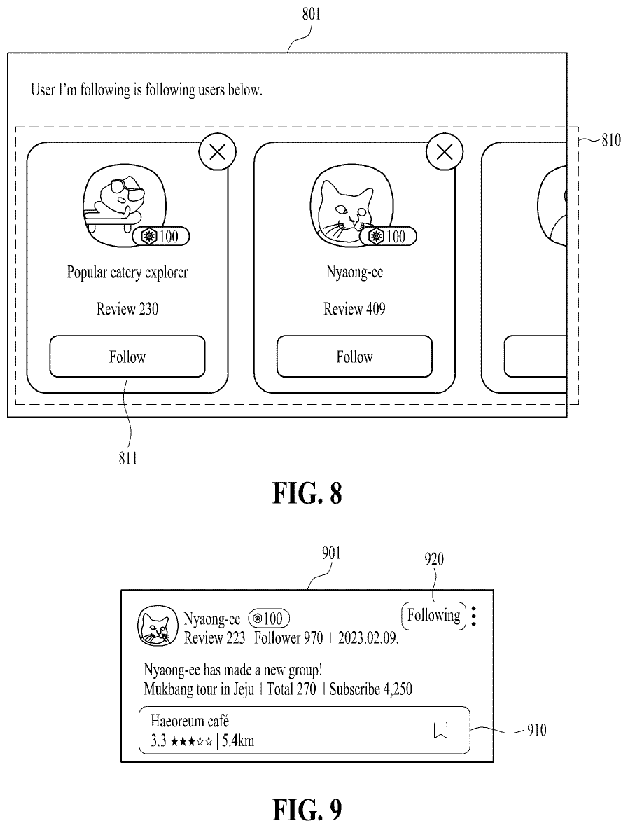

For example, the feed page 641 may include a second type of feed content related to a recommendation corresponding to the second user account information. For example, referring to FIG. 8, a second type of feed content 801 may correspond to feed content that recommends a fourth user account, for which following is set by the second user account, as a following target. The feed content 801 may include a list 810 of the fourth user accounts. The feed content 801 may provide an interfacing object 811 for setting the fourth user account as a following target through each item included in the list 810 of the fourth user accounts. By an input selecting the interfacing object 811, the terminal of the first user account may set the fourth user account as a following target.

For example, the feed page 641 may include a third type of feed content related to an update of an item group that is subscribed to. For example, referring to FIG. 9, a third type of feed content 901 may correspond to feed content notifying that a new place object has been added to a place group included in subscription information. The feed content 901 may include an interfacing object 910 for providing information on the place object added to the place group. The interfacing object 910 may include at least one of identification information (e.g., a name and category of the place) of the added place object, evaluation information of the added place object, and distance information, which is information on a distance of the added place object from a location of a terminal of a first user account. By an input selecting the interfacing object 910, the screen may be converted to a screen that provides detailed information on the place. The screen providing the detailed information on the place may display a detail page regarding the place provided by the map app. The detail page regarding the place may include at least one of a map location, a category (e.g., a restaurant, a cafe, a beauty salon, and a park), a business name, an address, a phone number, or introduction information of the place.

The feed content 901 may include a message notifying that a new place object has been added to the place group. The feed content 901 may include information on a third user account that generated a place group and an interfacing object 920 for setting the third user account as a following target. By an input selecting the interfacing object 920, the terminal of the first user account may set the third user account as a following target.

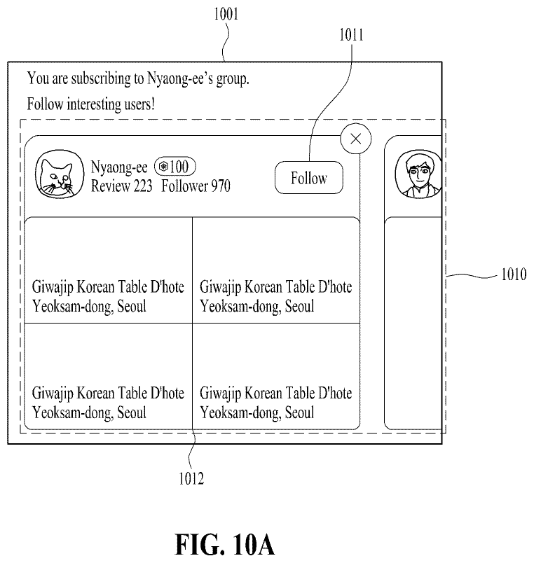

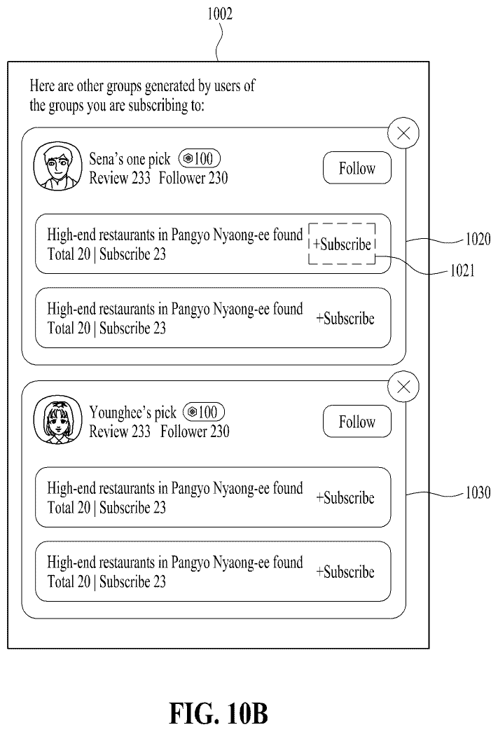

For example, the feed page 641 may include a fourth type of feed content related to a recommendation corresponding to a place group. For example, referring to FIG. 10A, a fourth type of feed content 1001 may correspond to feed content that recommends the third user account, which has generated the place group included in the subscription information, as a following target. The feed content 1001 may include a list 1010 of the third user accounts. The feed content 1001 may provide an interfacing object 1011 for setting the third user account as a following target through each item included in the list 1010 of the third user accounts. By an input selecting the interfacing object 1011, a terminal of a first user account may set the third user account as a following target.

The feed content 1001 may provide information on the third user account through each item included in the list 1010 of the third user account. For example, information on the third user account may include information on identification information (e.g., an ID, a nickname, and a name) of the third user account, information on a number of reviews generated by the third user account and a number of followers of the third user account, and the like. For example, information on the third user account may include summary information 1012 of a post generated by the third user account.

For example, referring to FIG. 10B, a fourth type of feed content 1002 may correspond to feed content that recommends a place group generated by the third user account as a subscription target. The feed content 1002 may include a list (e.g., a list 1020 and a list 1030) of place groups for each third user account. The feed content 1002 may provide an interfacing object 1021 for setting the place group as a subscription target through each item included in the list (e.g., the list 1020 and the list 1030) of place groups for each third user account. By an input selecting the interfacing object 1021, the place group may be set as a subscription target.

Information on the place group, such as a name of the place group, a number of place objects included in the place group, and a number of subscriptions to the place group, may be provided through each item included in the list (e.g., the list 1020 and the list 1030) of place groups for each third user account.

The feed content 1002 may include information on the third user account that generated the place group. For example, the feed content 1002 may include, for each list (e.g., the list 1020 and the list 1030), the identification information (e.g., an ID, a nickname, and a name) of the third user account, information on a number of reviews generated by the third user account and a number of followers of the third user account, and the like.

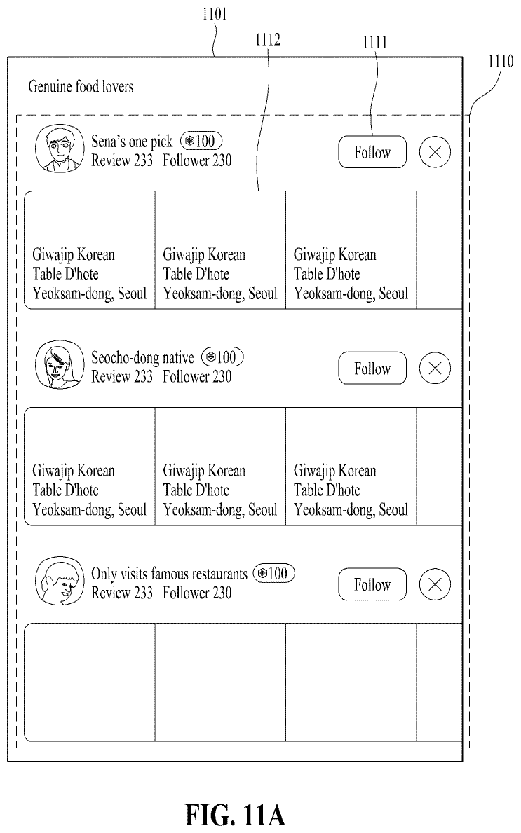

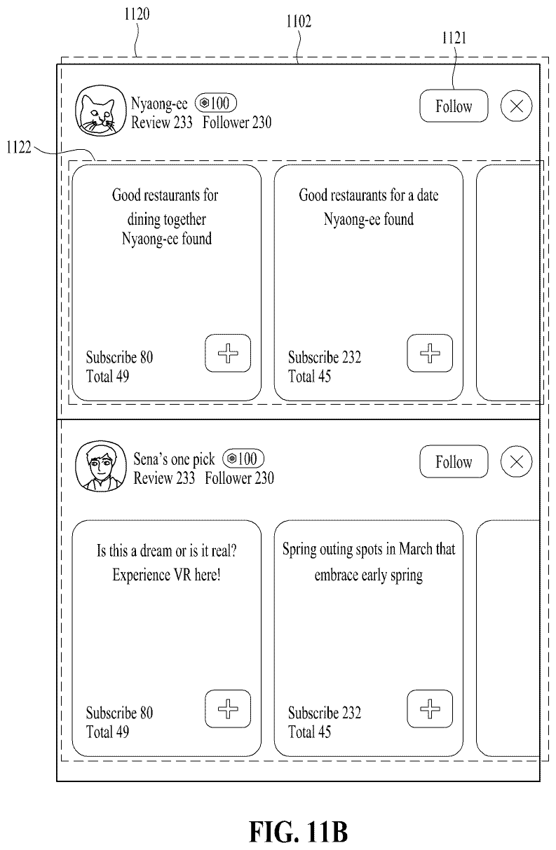

For example, the feed page 641 may include a fifth type of feed content related to a recommendation of a following target. For example, referring to FIG. 11A, a fifth type of feed content 1101 may correspond to feed content that recommends a candidate user account, which is determined by criteria regarding a post, as a following target. For example, the candidate user account determined by the criteria regarding a post may include at least one user account extracted based on at least one of a number of generated posts or a generation time of a post.

For example, the candidate user account determined by the criteria regarding a post may include at least one user account extracted based on a location of a terminal of a first user account. For example, a user account that has generated a review of a place located within a threshold distance from the location of the terminal may be determined as the candidate user account. For example, among all user accounts that have generated a review of the place located within the threshold distance from the location of the terminal, a portion of user accounts may be determined as the candidate user account, in an order of a user account including the most amount of data of the review of the place located within the threshold distance from the location of the terminal, or in an order of the most recent generation time of the place located within the threshold distance from the location of the terminal.

The feed content 1101 may include a list 1110 of candidate user accounts. The feed content 1101 may provide an interfacing object 1111 for setting the candidate user account as a following target through each item included in the list 1110 of candidate user accounts. By an input selecting the interfacing object 1111, the terminal of the first user account may set the candidate user account as a following target.

The feed content 1101 may provide information on the candidate user account through each item included in the list 1110 of candidate user accounts. For example, the information on the candidate user account may include information on identification information (e.g., an ID, a nickname, and a name) of the candidate user account, information on a number of reviews generated by the candidate user account and a number of followers of the candidate user account, and the like. For example, information on a candidate user account may include summary information 1112 of the post generated by the candidate user account.

For example, referring to FIG. 11B, a fifth type of feed content 1102 may correspond to feed content that recommends a candidate user account, which is determined by criteria regarding a place group, as a following target. For example, the candidate user account determined by the criteria regarding a place group may include at least one user account extracted based on at least one of a number of subscriptions to the generated place group, a number of views of the generated place group, or a generation time of the place group.

For example, the candidate user account determined by the criteria regarding a place group may include at least one user account extracted based on the location of the terminal of the first user account. For example, a user account that has generated a place group including a place object located within a threshold distance from the location of the terminal may be determined as the candidate user account. For example, among all user accounts that have generated the place group including the place object located within a threshold distance from the location of the terminal, a portion of user accounts may be determined as the candidate user account, in an order of a user account including the most amount of data of the place group including the place object located within a threshold distance from the location of the terminal, or in an order of the most recent generation time of the place group including the place object located within a threshold distance from the location of the terminal.

The feed content 1102 may include a list 1120 of candidate user accounts. The feed content 1102 may provide an interfacing object 1121 for setting the candidate user account as a following target through each item included in the list 1120 of candidate user accounts. By an input selecting the interfacing object 1121, the terminal of the first user account may set the candidate user account as a following target.

The feed content 1102 may provide information on the candidate user account through each item included in the list 1120 of candidate user accounts. For example, the information on the candidate user account may include the information on identification information (e.g., an ID, a nickname, and a name) of the candidate user account, the information on the number of reviews generated by the candidate user account and the number of followers of the candidate user account, and the like. For example, the information on the candidate user account may include summary information 1122 of the place group generated by the candidate user account.

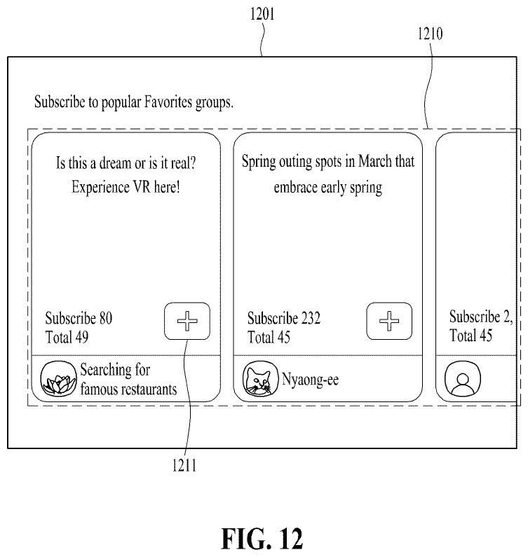

For example, the feed page 641 may include a sixth type of feed content related to a recommendation of a subscription target. For example, referring to FIG. 12, a sixth type of feed content 1201 may correspond to feed content that recommends a candidate place group, which is determined based on at least one of a number of subscriptions or a number of views, as a subscription target.

For example, the candidate place group may include at least one place group extracted based on a location of a terminal of a first user account. For example, a place group including a place object located within a threshold distance from the location of the terminal may be determined as a candidate place group. For example, among all place groups including place objects within a threshold distance from the location of the terminal, a portion of place groups may be determined as a candidate place group in an order of a place group including the most number of place objects within the threshold distance from the location of the terminal or in an order of the most recent generation time.

The feed content 1201 may include a list 1210 of candidate place groups. The feed content 1201 may provide an interfacing object 1211 for setting the candidate place group as a subscription target through each item included in the list 1210 of candidate place groups. By an input selecting the interfacing object 1211, the terminal of the first user account may set the candidate place group as a subscription target.

The feed content 1201 may include information on a user account that has created the candidate location group. For example, the feed content 1201 may include identification information (e.g., an ID, a nickname, and a name) of the user account that has generated the candidate location group.

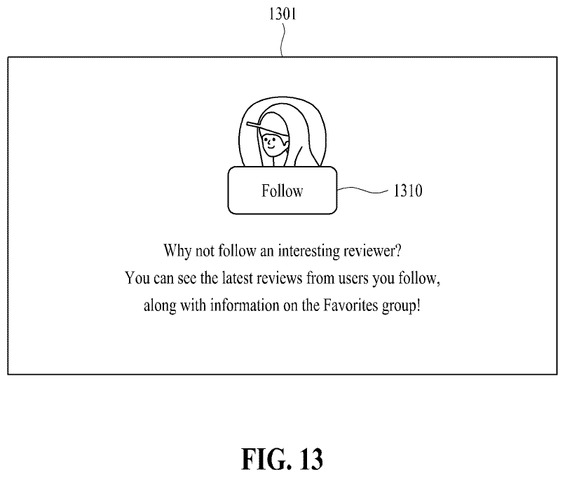

For example, the feed page 641 may include a seventh type of feed content related to inducing a following setting. For example, referring to FIG. 13, a seventh type of feed content 1301 may include a message inducing a following setting. The feed content 1301 may include an interfacing object 1310 for requesting a list of user accounts recommended as a following target. By an input selecting the interfacing object 1310, the list of user accounts recommended as a following target may be provided. The user accounts recommended as a following target may be determined by various recommendation logic.

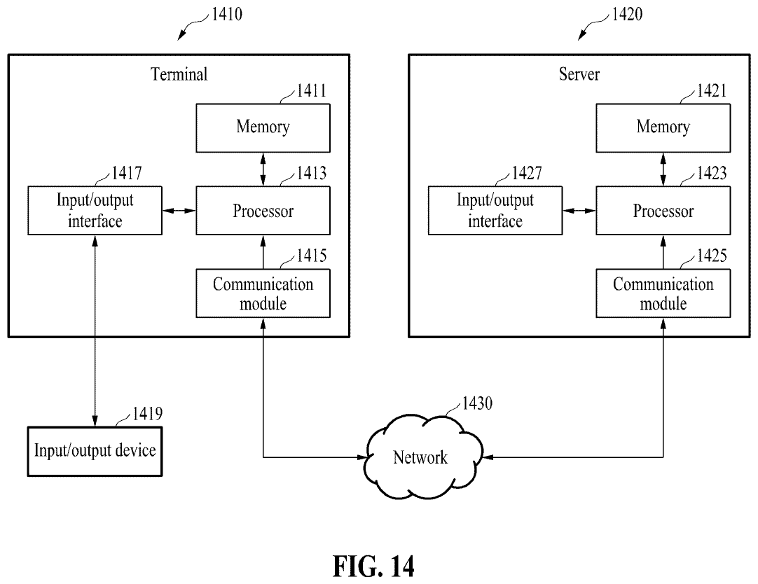

FIG. 14 is a diagram illustrating an example of a hardware configuration of a system for a social networking service, according to an embodiment.

Referring to FIG. 10, the system may include a terminal 1410 and a server 1420 connected to each other through a network 1430. For example, the server 1420 may include a server that provides the social networking service described above. For example, the terminal 1410 may include a terminal that uses a service provided by the server 1420. For example, the terminal 1410 may include the terminal of the first user account described above.

The terminal 1410 may be a mobile terminal implemented as a computer device. For example, the terminal 1410 may communicate with the server 1420 and/or other electronic devices through the network 1430 using a wired or wireless communication method.

The server 1420 may be implemented as one or more computer devices providing commands, code, files, content, services, and the like by communicating with the terminal 1410 and/or another server through the network 1430. A communication method may not be limited and may include a communication method using a communication network (e.g., a mobile communication network, wired Internet, wireless Internet, and a broadcasting network) that may be included in the network 1430 and a short-distance wireless communication method between devices. For example, the network 1430 may include one or more networks among networks, such as a personal area network (PAN), a local area network (LAN), a campus area network (CAN), a metropolitan area network (MAN), a wide area network (WAN), a broadband network (BBN), the Internet, and the like.

The server 1420 may provide a file for installing an application to the terminal 1410 accessing the server 1420 through the network 1030. In this case, the terminal 1410 may install an application (e.g., an app related to a social networking service) using a file provided by the server 1420. In addition, by control of an operating system (OS) and at least one program (e.g., a browser or an installed application) that are included in the terminal 1410, the terminal 1410 may access the server 1420 and receive a service or content provided by the server 1420. For example, when the terminal 1410 transmits a service request message to the server 1420 through the network 1430 by control of the application, the server 1420 may transmit code corresponding to the service request message to the terminal 1410 and the terminal 1410 may provide a user with content by composing and displaying a screen according to the code.

The terminal 1410 and the server 1420 may respectively include memories 1411 and 1421, processors 1413 and 1423, communication modules 1415 and 1425, and input/output interfaces 1417 and 1427.

The processors 1413 and 1423 may perform at least one operation of a terminal of a user account registered to the social media service described above with reference to FIGS. 1 to 13. For example, the processor 1413 may perform an operation of setting at least one of subscription to a generated item group or following for another user account and an operation of displaying a feed page generated based on the setting.

The processor 1423 may perform at least one operation related to providing the social networking service described above with reference to FIGS. 1 to 13. For example, the processor 1423 may perform at least one of determining a layout of a feed page based on the following information corresponding to the first user account and the subscription information corresponding to the first user account described above with reference to FIG. 1, determining a type of feed content corresponding to the determined layout based on the following information and the subscription information, or providing a feed page on which the feed content determined based on the layout is arranged to a terminal of the first user account.

The processors 1413 and 1423 may be configured to process commands of a computer program by performing basic arithmetic, logic, and an input/output operation. The commands may be provided to the processors 1413 and 1423 by the memories 1411 and 1421 or the communication modules 1415 and 1425.

The memories 1411 and 1421 may be a computer-readable storage medium and may be volatile or non-volatile memory. The memories 1411 and 1421 may store information on the social networking service described above with reference to FIGS. 1 to 13. For example, the memory 1421 may store at least one of user account information registered to a social networking service, content information generated by the user account, or subscription information and following information corresponding to the user account.

The memory 1411 may include code for an app related to a social networking service that is installed and runs on the terminal 1410 by files provided by the server 1420 through the network 1430.

The memory 1421 may store a program in which operations for the social networking service described above with reference to FIGS. 1 to 13 are implemented.

The communication modules 1415 and 1425 may provide a function for the terminal 1410 and the server 1420 to communicate with each other through the network 1430 and a function for the terminal 1410 and the server 1420 to communicate with another electronic device or another server through the network 1430.

For example, a request generated by the processor 1413 of the terminal 1410 according to program code of an app related to a social networking service stored in a recording device, such as the memory 1411, may be transmitted to the server 1420 through the network 1430.

For example, a control signal, a command, content, a file, and the like provided under control by the processor 1423 of the server 1420 may be received by the terminal 1410 through the communication module 1415 of the terminal 1410 after passing through the communication module 1425 and the network 1430.

The input/output interfaces 1417 and 1427 may be a means for interfacing with an input/output device 1419. For example, an input device may include a device such as a keyboard or a mouse, and an output device may include a device such as a display for displaying a communication session of an application. In another example, the input/output interface 1417 may be a means for interfacing with a device that has input and output functions integrated together, such as a touch screen. More specifically, when the processor 1413 of the terminal 1410 processes commands of a computer program loaded on the memory 1411, content or a service screen composed by using data provided by the server 1420 may be displayed on a display through the input/output interface 1417. An input received from a user through the input/output device 1419 may be provided in a form processable by the processor 1413 of the terminal 1410 through the input/output interface 1417.

The terminal 1410 and the server 1420 may include other components that are not illustrated in FIG. 14. For example, the terminal 1410 may be implemented to include at least a portion of the input/output device 1419 described above or may further include other components such as a transceiver, a global positioning system (GPS) module, a camera, various types of sensors, a database, and the like.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An operating method of a server that provides a social networking service, the method comprising:
determining a layout of a feed page based on following information corresponding to a first user account and subscription information corresponding to the first user account;
determining a type of feed content corresponding to the determined layout, based on the following information and the subscription information; and
providing, to a terminal of the first user account, the feed page on which the determined feed content is arranged based on the layout.

2. The method of claim 1, wherein the following information comprises one of second user account information, which is information related to a second user account for which following is set by the first user account, and information indicating that there is no other user account for which following is set by the first user account.

3. The method of claim 1, wherein the subscription information comprises one of item group information, which is information related to an item group to which subscription is set by the first user account, and information indicating that there is no item group to which subscription is set by the first user account.

4. The method of claim 1, wherein the determining of the layout of the feed page comprises at least one of:
determining the layout of the feed page to include arrangement information of a first type of feed content related to content generated by a second user account, based on second user account information included in the following information; or
determining the layout of the feed page to include arrangement information of a second type of feed content related to a recommendation corresponding to the second user account information.

5. The method of claim 1, wherein the determining of the feed content comprises at least one of:
generating, based on arrangement information of a first type of feed content included in the layout, feed content comprising a post generated by a second user account included in the following information; or
generating, based on the arrangement information of the first type of feed content included in the layout, feed content related to an item group generated by the second user account.

6. The method of claim 1, wherein the determining of the feed content comprises:
generating, based on arrangement information of a second type of feed content included in the layout, feed content that recommends a fourth user account, for which following is set by a second user account included in the following information, as a following target.

7. The method of claim 1, wherein the determining of the layout of the feed page comprises at least one of:
determining, based on an item group included in the subscription information, the layout of the feed page to include arrangement information of a third type of feed content related to an update of the item group; or
determining the layout of the feed page to include arrangement information of a fourth type of feed content related to a recommendation corresponding to the item group.

8. The method of claim 1, wherein the determining of the feed content comprises at least one of:
generating feed content notifying that new item information has been added to an item group included in the subscription information, based on arrangement information of a third type of feed content included in the layout; or
generating feed content notifying that item information has been deleted from the item group included in the subscription information, based on the arrangement information of the third type of feed content included in the layout.

9. The method of claim 1, wherein the determining of the feed content comprises at least one of:
generating, based on arrangement information of a fourth type of feed content included in the layout, feed content that recommends a third user account, which has generated an item group included in the subscription information, as a following target; or
generating, based on the arrangement information of the fourth type of feed content included in the layout, feed content that recommends another item group generated by the third user account as a subscription target.

10. The method of claim 1, wherein the determining of the layout of the feed page comprises:
determining the layout of the feed page to include at least one of arrangement information of a fifth type of feed content related to a recommendation of a following target or arrangement information of a sixth type of feed content related to a recommendation of a subscription target.

11. The method of claim 1, wherein the determining of the feed content comprises:
extracting at least one user account as a candidate based on at least one of location information of the terminal of the first user account, a number of generated posts, or a generation time of a post; and
generating feed content that recommends following the extracted candidate.

12. The method of claim 1, wherein the determining of the feed content comprises:
extracting at least one user account as a candidate based on at least one of location information of the terminal of the first user account, a number of subscriptions to a generated item group, a number of views of a generated item group, or a generation time of an item group; and
generating feed content that recommends following the extracted candidate.

13. The method of claim 1, wherein the determining of the feed content comprises:
extracting at least one item group as a candidate based on at least one of location information, a number of subscriptions, or a number of views of the terminal of the first user account; and
generating feed content that recommends a subscription to the extracted candidate.

14. An operating method of a terminal of a user account registered to a social media service, the method comprising:
setting at least one of subscription to a generated item group or following of another user account; and
displaying a feed page generated based on the setting,
wherein a layout of the feed page is determined based on a presence of an item group to which subscription is set by the user account and a presence of another user account for which following is set by the user account.

15. A non-transitory computer-readable storage medium storing instructions that, when executed by at least one processor, cause the at least one processor to perform the method of claim 1.

16. A server that provides a social networking service, the server comprising one or more processors configured to:
determine a layout of a feed page based on following information corresponding to a first user account and subscription information corresponding to the first user account;
determine a type of feed content corresponding to the determined layout, based on the following information and the subscription information; and
provide, to a terminal of the first user account, the feed page on which the determined feed content is arranged based on the layout.

17. The server of claim 16, wherein, when determining the layout of the feed page, the one or more processors are configured to perform at least one of:
determining the layout of the feed page to include arrangement information of a first type of feed content related to content generated by a second user account, based on second user account information included in the following information; or
determining the layout of the feed page to include arrangement information of a second type of feed content related to a recommendation corresponding to the second user account information.

18. The server of claim 16, wherein, when determining the layout of the feed page, the one or more processors are configured to perform at least one of:
determining, based on an item group included in the subscription information, the layout of the feed page to include arrangement information of a third type of feed content related to an update of the item group; or
determining the layout of the feed page to include arrangement information of a fourth type of feed content related to a recommendation corresponding to the item group.

19. The server of claim 16, wherein, when determining the layout of the feed page, the one or more processors are configured to:
determine the layout of the feed page to include at least one of arrangement information of a fifth type of feed content related to a recommendation of a following target or arrangement information of a sixth type of feed content related to a recommendation of a subscription target.

20. A terminal of a user account registered to a social media service, the terminal comprising one or more processors configured to:
set at least one of a subscription to a generated item group or following for another user account; and
display a feed page generated based on the setting,
wherein a layout of the feed page is determined based on a presence of an item group to which subscription is set by the user account and a presence of another user account for which following is set by the user account.
